(19) United States
(12) Patent Application Publication
(10) Pub. No.: US 2013/0118069 A1
(43) Pub. Date: May 16, 2013

(54) VINE TRAINING SYSTEM

(71) Applicants: Jeffrey D. Hunt, Perrysburg, OH (US); Michael Robert Baker, Kokomo, IN (US); Rick Paul, Kokomo, IN (US); Eric Anthony Mihal, Crown Point, IN (US)

(72) Inventors: Jeffrey D. Hunt, Perrysburg, OH (US); Michael Robert Baker, Kokomo, IN (US); Rick Paul, Kokomo, IN (US); Eric Anthony Mihal, Crown Point, IN (US)

(73) Assignee: ATKORE INTERNATIONAL, Harvey, IL (US)

(21) Appl. No.: 13/297,313

(22) Filed: Nov. 16, 2011

(51) Int. Cl. A01G 17/14

(52) U.S. Cl. 47/46

(57) ABSTRACT

A vine training system is disclosed, including an improved vineyard stake. The system includes a vineyard stake, a training wire, and end posts for holding tension in the wire. A plurality of vineyard stakes are positioned between the end posts to keep the wire a desired distance above the ground. The stake engages the wire via openings in the tube wall. The openings include a central horizontal leg and oppositely disposed vertical legs, such that the legs form a tab therebetween. The wire is receivable in the opening, and the tab retains the wire to fix it to the stake. This engagement is achieved without the use of clips. The stake can include a plurality of openings so that the wire can be positioned and repositioned at any of a variety of distances above the ground, to accommodate vine growth. Other embodiments are disclosed and claimed.

### BACKGROUND OF THE INVENTION

1. Field of the Invention

Embodiments of the invention generally relate to the field of systems for use in vine training, and more particularly to an improved vineyard stake for use in training grape vines.

2. Discussion of Related Art

In wine making, vine training systems are used to assist in the establishment and maintenance of grape vines. Vine training systems are often used to shape the growth of grape vines so that the vines grow in a way that enhances grape growth and ripening. A trellis is often part of traditional vine training systems. Technically speaking, the trellis refers to the actual stakes, posts, wires or other structures to which the growing vine is attached. FIGS. 1A and 1B show an example of a traditional vineyard training system 1. The vine stakes 2 are usually made of thin-walled steel, and the profiles of these stakes are typically angles, U-shapes or T-posts. One problem with such stake designs is that their thin-walled angle, U-shaped or T-post construction makes them difficult to drive into hard soil without deforming the top or buckling the side walls.

Another component of traditional vine training system is a wire 4 which is strung horizontally between stakes 2. The wire helps the grape vines grow upward and keeps the cordons (vine arms) off the ground. Attaching the training wire to the stake requires the use of a special clip 6. The clip is looped through a hole in the stake, and is manually twisted about the wire 2, usually using a tool such as pliers, to secure the wire in place at a desired height above the ground. As will be appreciated, this operation is labor intensive, as the clip must be twisted about the wire at each stake 2.

Early in the training process, it may be necessary to change the height of the wire 2 above the ground, to accommodate vine growth and to keep the cordons from touch the ground as previously noted. Such height changes can be difficult and time intensive using traditional vine training arrangements because each clip 6 must to be removed and repositioned on the stake 2 to move the wire 4 up or down a desired amount.

In addition, with current designs, the clips can tend to fall off of or get caught in the grape harvesting machinery, resulting in metal fragments being collected and mixed in with the harvested grapes.

Further, current stake designs also suffer from substantial corrosion as they are usually made from raw steel with no exterior protection, and as can be appreciated, the training systems are continually exposed to the outdoor environment.

FIG. 1B shows typical end posts 8 used to hold the wire 4 in tension. As can be seen, the end posts are wooden posts, and the wire 4 is fixed to the posts by wrapping and twisting the wire around the post 8. As can be appreciated, this is a cumbersome arrangement, and as with prior stake designs, makes adjusting the wire height an arduous task.

Thus, there is a need for an improved vine training system design that simplifies attachment of training wires to stakes by eliminating the need for clips, which facilitates movement of the training wires up or down the stakes as needed, which minimizes corrosion of stakes, and which facilitates driving of the stake into hard ground without deforming the stake. There is also a need for an improved end post design that similarly facilitates movement of the training wires up or down the end post as needed.

### SUMMARY OF THE INVENTION

An improved vineyard training system is disclosed that overcomes the aforementioned deficiencies. The disclosed system includes a vineyard stake made from a tubular profile that imparts high stiffness and strength required to enable the stake to be driven into hard soil without buckling or deforming, and that does not require added supplemental stiffening components. In addition, the bottom end of the stake may be provided with a pointed shape to facilitate penetration into the soil. Openings are provided in the side walls of the stake to enable easy engagement of a training wire with the stake. Providing such openings also facilitates the placement of the training wire at any of a variety of distances above the ground, thus enabling quick adjustment of the system to accommodate vine growth. To prevent corrosion, the stake may include a zinc coating to offer protection against corrosive environments of the wine growing areas.

A vineyard stake is disclosed. The stake includes a tubular member having first and second ends and a longitudinal axis. A plurality of openings can be formed in a wall of the tubular member. The plurality of openings can be spaced along the longitudinal axis. At least one of the plurality of openings has a central horizontal leg and first and second oppositely disposed vertical legs. The horizontal and vertical legs form a protruding tab therebetween. The protruding tab is configured such that when a wire is laterally inserted in the opening, the wire is retained behind the protruding tab to fix the wire to the tubular member.

A vine training system is disclosed. The system includes a vineyard stake comprising a tubular member having first and second ends and a longitudinal axis, an elongated training wire, and first and second end posts for receiving first and second ends of the elongated training wire to maintain a tension in the elongated training wire. The tubular member includes an opening in a wall thereof. The opening includes a central horizontal leg and first and second oppositely disposed vertical legs. The horizontal and vertical legs form a protruding tab therebetween. The opening is configured to receive an intermediate portion of the elongated training wire therein and the protruding tab is configured to retain the intermediate portion of the elongated training wire to fix the elongated training wire to the tubular member.

### BRIEF DESCRIPTION OF THE DRAWINGS

The accompanying drawings illustrate preferred embodiments of the disclosed device so far devised for the practical application of the principles thereof, and in which:

FIGS. 1A and 1B are illustrations of a traditional vine training system;

FIG. 2 is a view of the disclosed vine training system implemented in a vineyard;

FIGS. 3A and 3B are side and detail views, respectively, of a first embodiment of a stake for use with the vine training system of FIG. 2, while FIG. 3C is a cross-section view of the stake of FIGS. 3A and 3B taken along line 3C-3C of FIG. 3A;

FIGS. 4A and 4B are front and detail views, respectively, of the stake of FIGS. 3A and 3B;

FIGS. 5A and 5B are side and detail views, respectively, of a second embodiment of a stake for use in the vine training system of FIG. 2;

FIGS. 6A and 6B are front and detail views, respectively, of the stake of FIGS. 5A and 5B, while FIG. 6C is a cross-section view of the stake of FIGS. 5A and 5B taken along line 6C-6C of FIG. 6A;

FIGS. 7 and 8 are detail views of exemplary positionings of a training wire with respect to the stake of FIGS. 4A-5B;

FIG. 9 is a detail view of an exemplary driving point for the stakes of FIGS. 4A-6c;

FIGS. 10A through 10C are opposing side views, and a detail view, respectively, of an exemplary end post for use with the vine training system of FIG. 2; and

FIGS. 11A through 11D are isometric views of the end post of FIGS. 10A-10C.

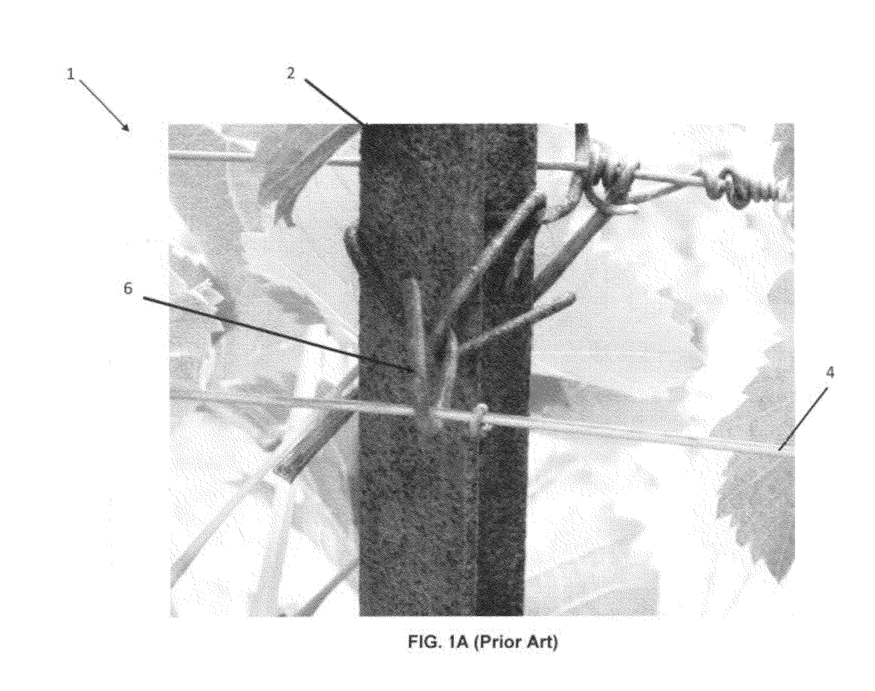

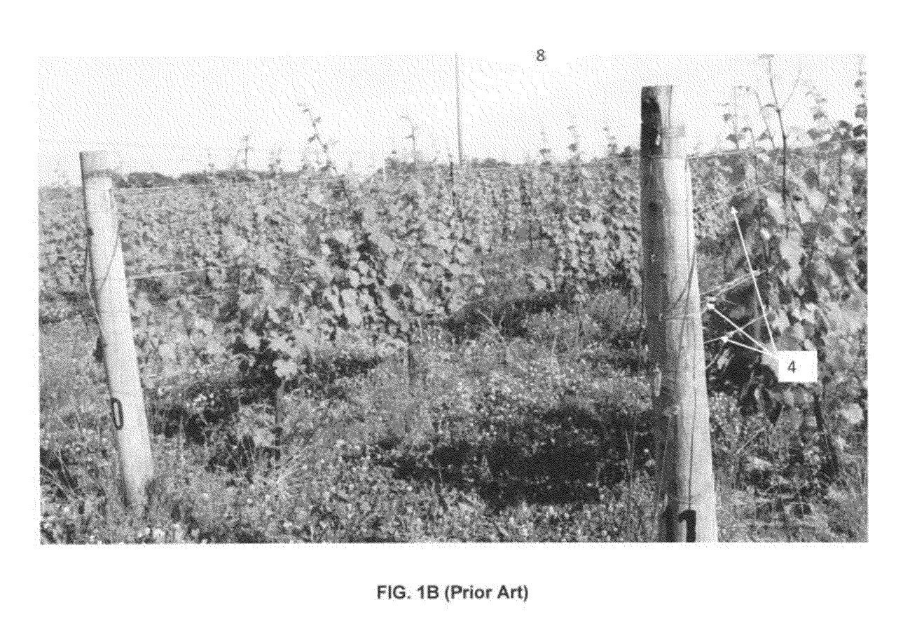

### DESCRIPTION OF EMBODIMENTS

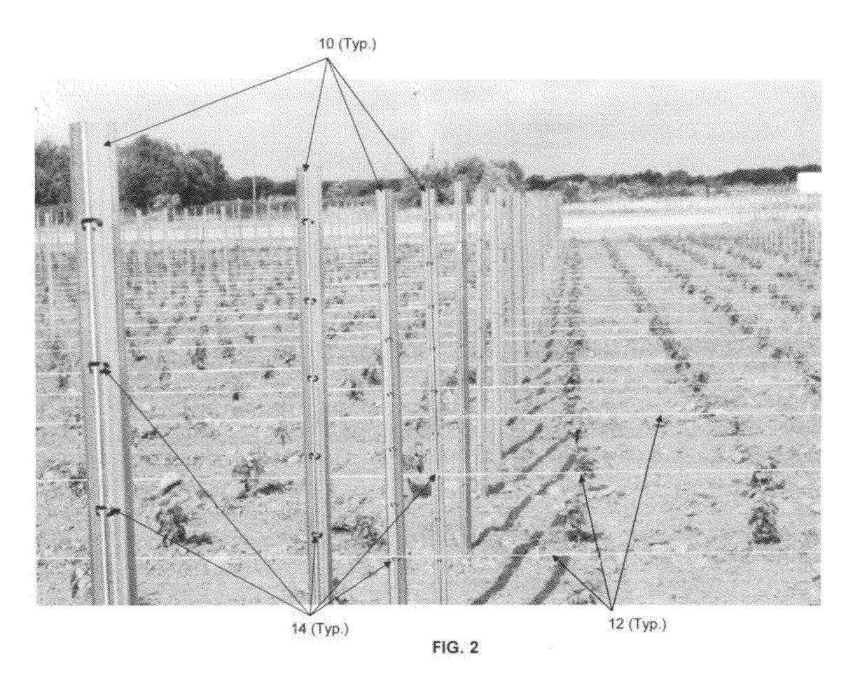

An exemplary vine training system according to the disclosure is shown in FIG. 2 shows a plurality of vineyard stakes 10 positioned in a grid pattern throughout a vineyard. Training wires 12 are engaged with openings 14 formed in the stakes 10 to hold the wires at a desired position above the ground. As can be seen, the stake/wire engagement does not require the use of clips.

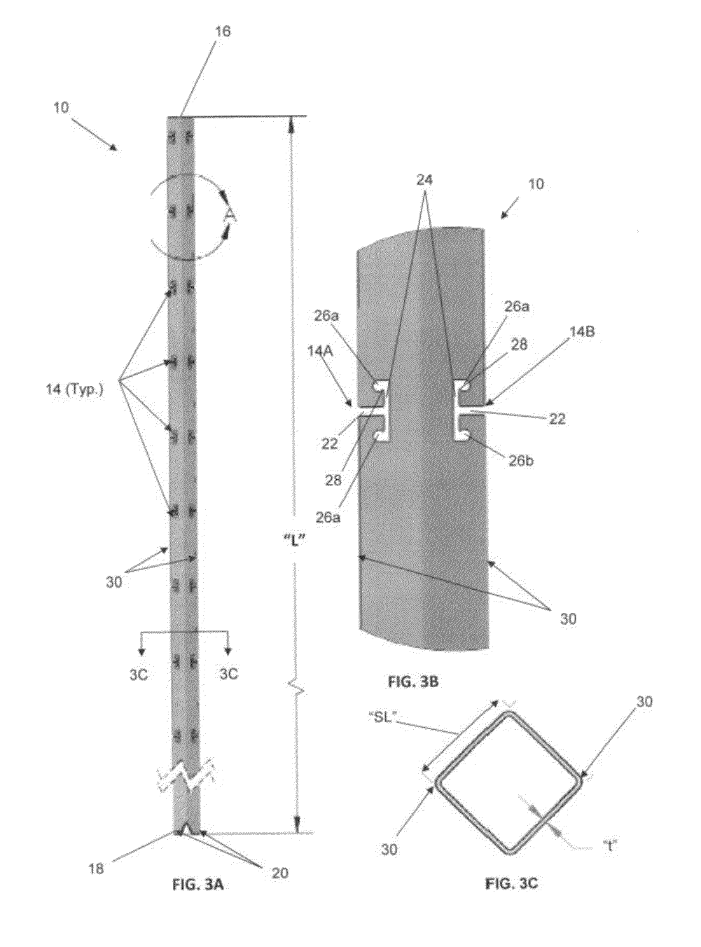

FIGS. 3A-3C show an exemplary vineyard stake 10, which may be an elongated tubular (i.e., hollow) member having a length “L,” and first and second ends 16, 18 disposed at opposing ends thereof. A plurality of openings 14 may be formed through the wall of the member at spaced apart intervals along the length “L.” The first end 16 may be configured for receiving a driving force by, for example, a sledgehammer, to enable the stake 10 to be driven into soil at a desired location. In one embodiment, the second end 16 is simply a flat end. The second end 18 may include one or more points 20 to facilitate penetration of the soil during the driving operation. In one embodiment these points 20 can be formed by laser cutting, though other cutting/forming techniques could also be used.

In one embodiment, the stake 10 is a steel tube having a square shape in cross-section (see FIG. 3C), with side lengths “SL” of about 1.5 inches. The tube may be formed from 16 gage material (0.065-inch nominal wall thickness “t”). The length “L” may be about 96-inches. Making the stake 10 from such a square tubular member provides a desired high stiffness for the stake which will not buckle or bend when the stake is hammered into hard soil.

As noted, the stake 10 can include a plurality of openings 14 formed in the stake wall. As more clearly seen in FIG. 3B, pairs of openings 14A, 14B are positioned in direct opposition on the sides of the stake 10. This arrangement enables a training wire 12 to be engaged with either side of the stake 10. It also could enable a pair of training wires 12 to be engaged a single stake. It will be appreciated, however, that providing opposing openings is not critical, and that only a single opening (14A or 14B) could be used.

FIG. 3B shows the geometry of the openings 14 which, in the illustrated embodiment, appear as T-shapes that have been rotated by 90-degrees. Each opening 14 includes a central horizontal leg 22, a vertical leg 24 and upper and lower horizontal legs 26a, b. The upper and lower horizontal legs 26a, b may be configured to form a protruding nub 28 that resists movement of the wire 12 back toward the vertical leg 24 once the wire has been received in the associated leg 26a, b.

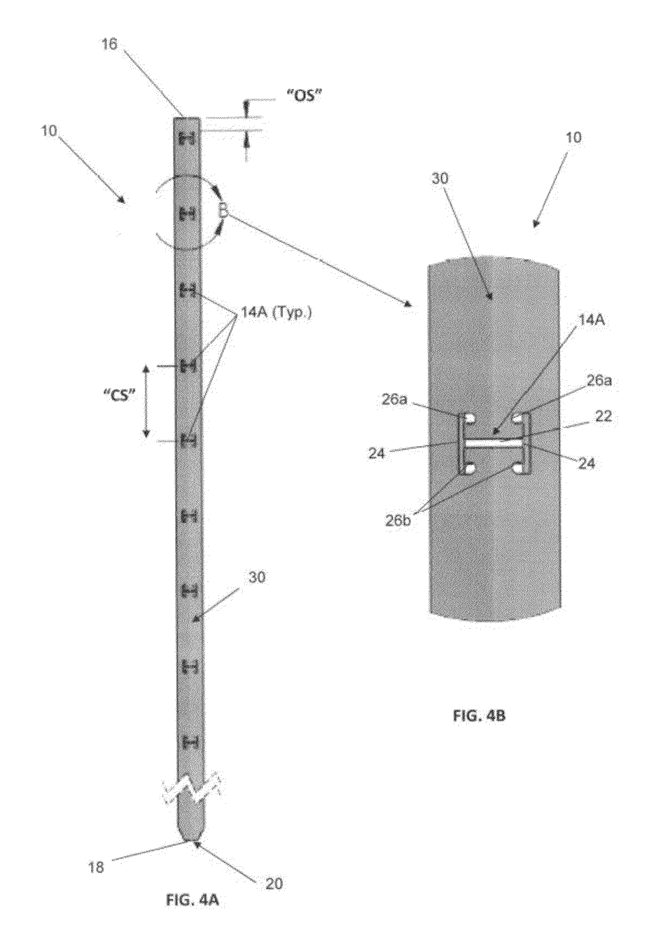

FIG. 4A shows a side view of the stake 10 of FIG. 3A. As can be seen, the plurality of openings (in this case openings 14A) are disposed on the observable side of the stake 10 at spaced apart intervals “CS.” In one embodiment the interval “CS” is about 6-inches, which provides about eight individual openings 14A along the length “L” of the stake 10 while retaining a desired column strength and stiffness of the stake. As previously noted, the first end 18 of the stake 10 may be configured to receive a driving force by, for example, a sledgehammer, to enable the stake 10 to be driven into soil at a desired location. Thus, the opening 14 adjacent to the first end 18 may be offset from that end by an offset distance “OS” to the end retains sufficient strength to withstand the driving force without being damaged. In one embodiment, the offset distance “OS” can be about 1-inch.

FIG. 4B shows a rotated view of one of the openings 14A as compared to the view of FIG. 3B. As can be seen, the opening 14a appears as a linked pair of rotated “T” shapes having central horizontal leg 22, vertical legs 24 and upper and lower horizontal legs 26a, b.

Importantly, the openings 14 are positioned so as to span the corners of the stake 10. With reference to FIG. 4B, opening 14A is shown spanning an associated apex 30 of the square tubular stake 10 so that one half of the opening 14A the resides on one side of the stake 10 while the other half of the opening resides on the adjacent side of the stake 10. Such an arrangement enables easy engagement of a training wire 12 with the openings 14A, B, and also ensures that the stake 10 retains substantial strength and stiffness.

The openings 14A, B can be laser cut into the tubular stake 10 to form the arrangement shown in FIGS. 3A-4B. Alternatively, the openings can be punched into strip material that is used to form the tubular stake 10. The openings could also be roll-punched after the tubular member has been formed.

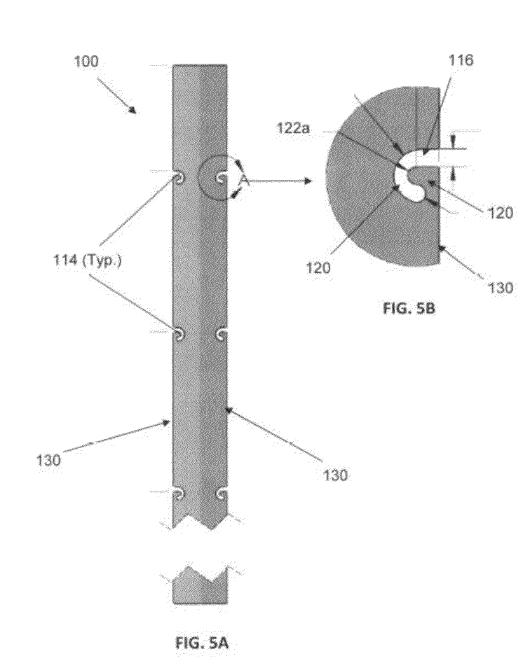

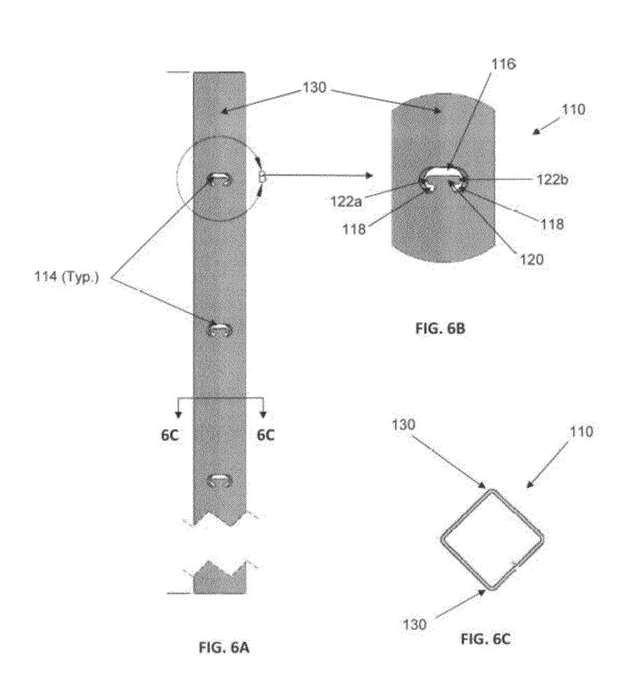

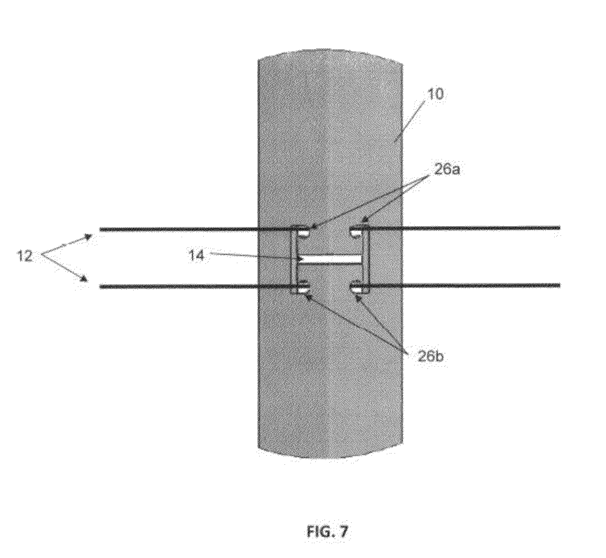

FIGS. 5A-6C illustrate a second embodiment of a vineyard stake 100 in which the openings 114 have a rotated “C” shape in lieu of the “T” shape of the previous embodiment. As compared to the embodiment of FIGS. 3A-4B, stake 100 may be stiffer and stronger because the openings 114 require the removal of less material from the walls of the stake.

As with the previous embodiment, the openings 114 are formed so as to span an associated apex 130 of the stake 100 to enhance the strength and rigidity of the stake while facilitating easy engagement of a training wire 12 with the openings 114.

FIGS. 5B and 6B show the details of one of the openings 114 of the stake 110. As noted, the openings 114 of this embodiment have a rotated “C” shape that includes an upper horizontal portion 116 that crosses the apex 130 of the stake 110, and a pair of descending legs 118 that run downward and slightly inward toward the apex 130 of the stake. As such, the opening 114 forms an included protrusion 120 having first and second side tab portions 122a, b. The protrusion 120 and side tab portion s 122a, b serve to retain a training wire 12 in the opening 114.

The stake 110 may be made from similar materials, and may have a similar overall geometry (i.e., length “L,” spacings between openings “CS,” offset distance “OS,” tubular profile with side lengths “SL” and nominal thickness “t”) as compared to the stake 10 described in relation to FIGS. 3A-4B. In addition, the stake 110 may have an end include one or more points 20 to enable the stake to penetrate the soil. Further, the openings 114 may be cut, punched or otherwise formed in the same manner as that described in relation to FIGS. 3A-4B.

It will be appreciated that although two particular designs have been described in relation to the disclosed openings 14, 140, other designs can also be used. In addition, it is contemplated that different opening designs may be used on a single stake 10, 100.

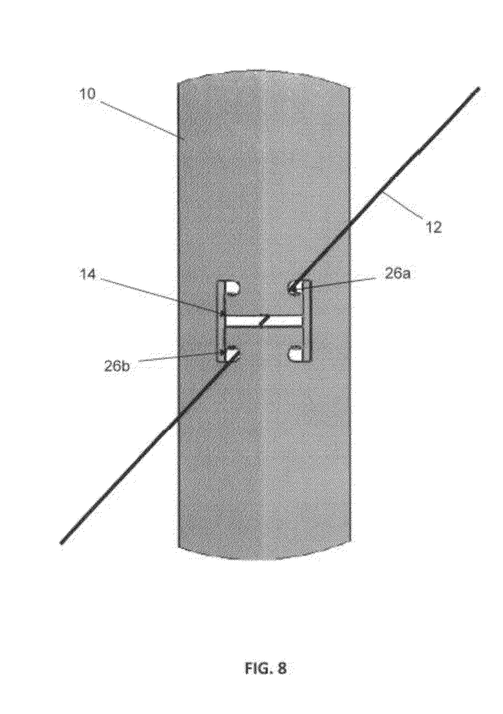

FIGS. 7 and 8 show a plurality of different positionings of training wires 12 in openings 14 of the stake 10 of FIGS. 3A-4B. FIG. 7 shows that a training wire can be engaged either with the upper horizontal legs 26a of the opening 14, or with the lower horizontal legs 26b of the opening. This arrangement provides a fine level of vertical adjustment of training wire 12 in cases in which moving the training wire 12 to the adjacent opening 14 would result in too great a vertical distance increase for accommodating a particular increment of new vine growth. FIG. 8 shows the positioning of a training wire for application in which the stakes 10 are installed on a hill or slope. Thus, the linked pair of rotated “T” shapes of the opening 14 enable the wire 12 to be run at an angle. As can be seen, the training wire 12 is received in the upper horizontal leg 26a of one linked T-shape, and in the lower horizontal leg 26b of the other linked T-shape.

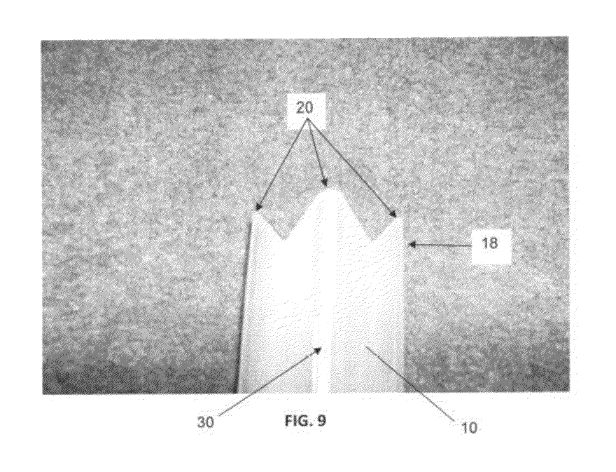

As previously noted, the disclosed stakes 10, 110 may be driven into the ground by applying force to the first end 16 using, for example, a sledge hammer. FIG. 9 shows a detail view of the second end 18 of the stakes 10, 110 which, as previously described, includes a plurality of points 20 to facilitate penetration of hard soil. In one embodiment, the first end 16 may be a closed section to provide an impact surface for the sledge when driving the stake 10 into the ground. A cap (now shown) can also be used to further protect the first end 16 of the stake 10 from hammering damage during installation. Such a cap may be a closed-end pipe section that can fit down over the first end 16 of the stake 10 to ensure that force is applied even to the first end as the sledge strikes.

The stake 10, 100 can be formed from a steel roll-form shape, preferably a square tubular roll form shape. The steel stake 10, 100 can also include a galvanized coating to minimize corrosion during extended exposure to the outdoor environment.

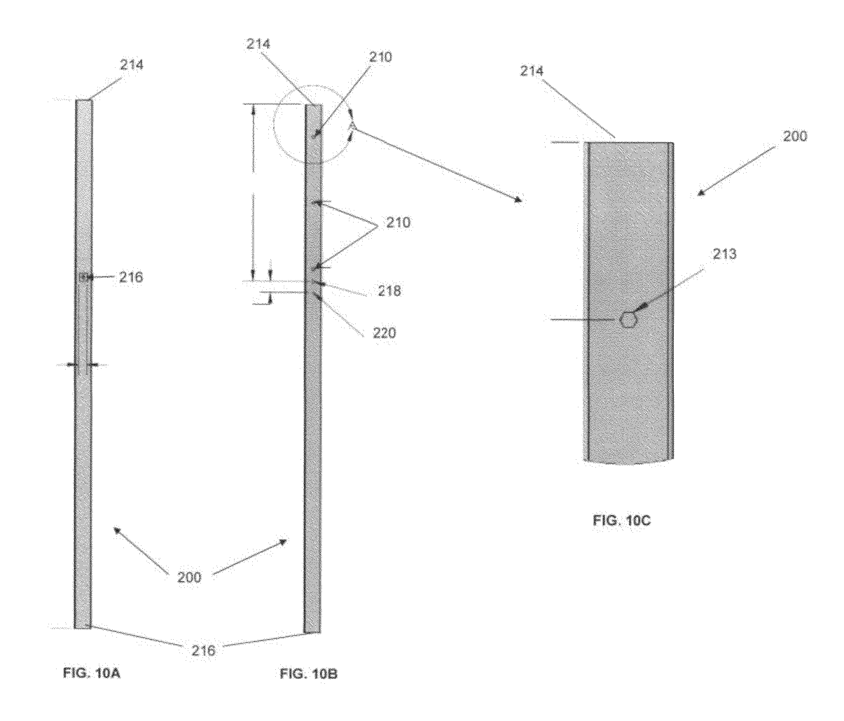

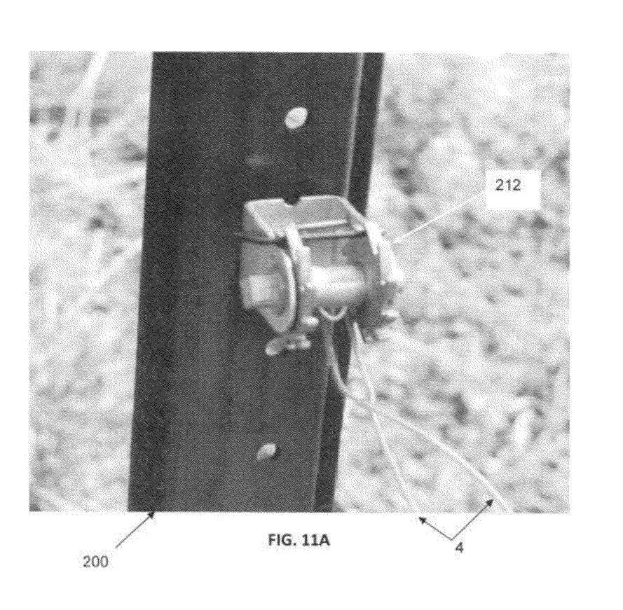

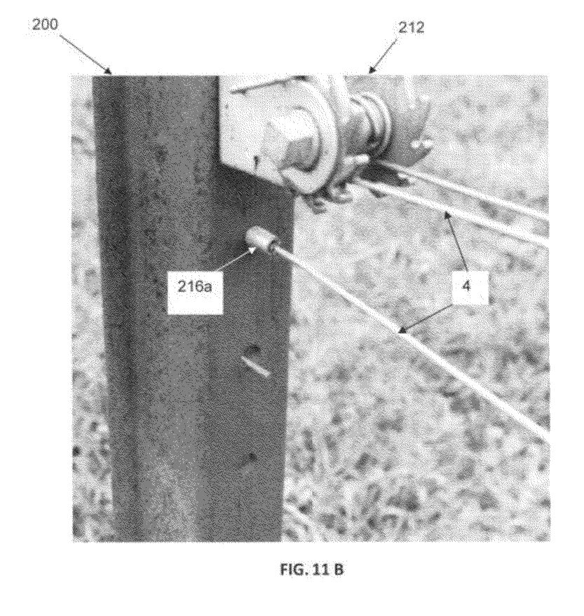

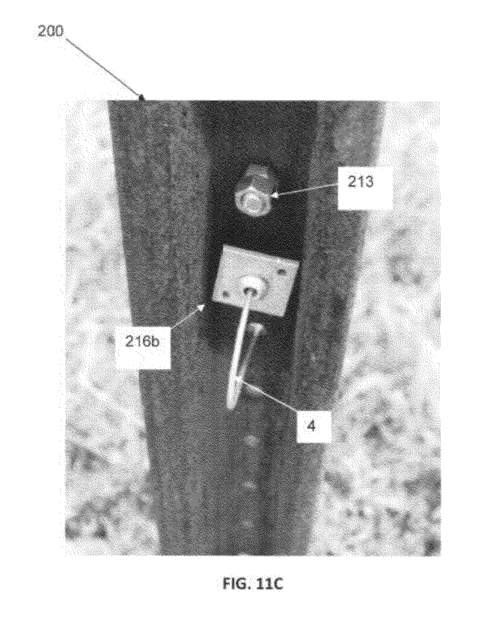

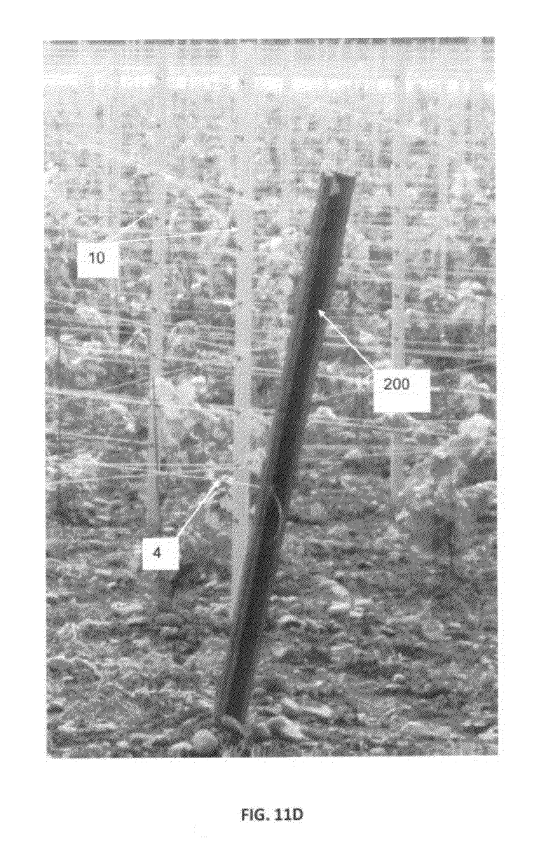

Referring now to FIGS. 10A-C, and 11A-D an exemplary end post 200 is shown for use in maintaining one or more training wires 12 at a desired tension in use. As can be seen from FIG. 2, the vine training system can include a large number of vineyard stakes 10 positioned in a grid pattern throughout a vineyard. For even moderately sized vineyards, the training wires 12 can be strung across substantial distances. Although the disclosed vineyard stakes 10, 110 will be positioned across the vineyard to hold the training wires 12 at a desired distance above the ground, the wires 12 must still be held at the ends. Thus, the training wires 12 can be engaged with a pair of end posts 200 positioned at opposite ends of each wire. In the illustrated embodiment, the end post 200 includes a plurality of openings positioned in spaced apart relation along the length of the post to enable a training wire 12 to be coupled to the end post 200 at a variety of distances above the ground. A first set of openings 210 facilitate attachment of one or more ratchet tensioning devices 212 shown in FIGS. 11A and 11B. A plurality of ratchet tensioning devices 212 may be installed at spaced apart intervals along the length of the end post 200. In one embodiment, a first ratchet tensioning device 212 is positioned about six inches from a top end 214 of the end post 200. Additional ratchet tensioning devices 212 can be spaced at twelve inch intervals along the length of the end post.

In use, a ratchet tensioning device 212 is coupled to a first end post 200 and connects to one end of the wire 4. In one embodiment, the end post 200 includes one or more threaded inserts 213, received in openings 210, which enables the tensioning devices 212 to be bolted directly to the post. The opposite end of the wire 4 may connect to an opposing end post 200 by feeding through an attachment element 216 fitted within an attachment opening 218. On an inside surface of the end post 200, the wire 4 may wrap around and back through another opening 220 so that the wire exits the post on the same side that it enters (see FIG. 11B). This arrangement reduces the chance for user injury from contact with wires extending from a back side of the post.

The attachment element 216 may include first and second portions 216a, 216b, where the first portion 216a is a tubular element that fits within the attachment opening 218 and the second portion 216b abuts a surface of the end post 200 to prevent the tubular element 216 from being pulled through the opening under tension from the wire 4. The first and second portions 216a, b may each have an opening sized to receive the wire 4 to enable the wire. In one embodiment, the opening in the first and/or second portion 216a, b includes features that enable the wire 4 to be fed through in a first direction, but prevents the wire 4 to travel in the reverse direction. Thus, in one embodiment, directionally oriented teeth are provided in the opening of the first and/or second portion 216. Alternatively, the first portion 216a may be crimped down on the wire once the wire is positioned within the attachment element 216. Once the wire 4 is fixed between an attachment element 216 of a first end post 200 and a ratchet tensioning device 212 of an opposite end post 200, the ratchet tensioning device can be actuated to draw the wire 4 tight between the end posts 200.

The end posts 200 can be any of a variety of roll form shapes. In one embodiment, the end posts 200 are square tubular members having three inch sides, and are made from 11 gauge steel. The end posts 200 may also have a protective coating to prevent corrosion. In one embodiment, the end posts 200 are galvanized.

The end posts 200 may have a bottom end 216 that can be flat, or it may have a pointed profile similar to that described in relation to FIG. 9 to facilitate driving of the end post 200 into hard soil.

As shown in FIG. 11D, the end posts 200 may be installed at an angle with respect to the ground. This angled installation can reduce the chance for sagging of the wires in use by providing a desired counter-tensioning of the end posts.

It will be appreciated that the disclosed design is not limited to use in vine training applications. Thus, the disclosed stake can also find use in other applications, such as fence or barrier systems. The stake could also be used as part of a highway cable barrier system.

While the invention has been disclosed with reference to certain embodiments, numerous modifications, alterations and changes to the described embodiments are possible without departing from the spirit and scope of the invention, as defined in the appended claims. Accordingly, it is intended that the present invention not be limited to the described embodiments, but that it has the full scope defined by the language of the following claims, and equivalents thereof.

What is claimed is:

1. A vineyard stake, comprising:
a tubular member having first and second ends and a longitudinal axis; and
a plurality of openings formed in a wall of the tubular member, the plurality of openings being spaced along the longitudinal axis;
wherein at least one of the plurality of openings has a central horizontal leg and first and second oppositely disposed vertical legs, the horizontal and vertical legs forming a protruding tab therebetween, the protruding tab configured such that when a wire is laterally inserted in the opening, the wire is retained behind the protruding tab to fix the wire to the tubular member.

2. The vineyard stake of claim 1, wherein the tubular member is a square tubular member, and wherein at least one of the plurality of openings spans an apex of the square tubular member.

3. The vineyard stake of claim 2, wherein the first and second vertical legs include ends that are angled toward the apex of the square tubular member.

4. The vineyard stake of claim 2, further comprising first and second horizontally oriented opening portions associated with ends of each of the first and second vertical legs, wherein the first and second horizontally oriented opening portions extend toward the apex of the square tubular member.

5. The vineyard stake of claim 4, wherein the first and second vertical legs comprise downwardly oriented vertical legs, the opening further comprising third and fourth vertical legs, wherein the third and fourth vertical legs are upwardly oriented.

6. The vineyard stake of claim 5, further comprising third and fourth horizontally oriented opening portions associated with ends of each of the third and fourth vertical legs, wherein the third and fourth horizontally oriented opening portions extend toward the apex of the square tubular member.

7. The vineyard stake of claim 1, wherein the tubular member has a zinc coating.

8. The vineyard stake of claim 1, wherein the first or second end includes at least one protrusion to facilitate penetration of soil when a force is applied to the other of the first or second end.

9. The vineyard stake of claim 1, wherein the plurality of openings are formed in opposite sides of the tubular member.

10. The vineyard stake of claim 1, wherein the plurality of openings are formed on only one side of the tubular member.

11. A vine training system, comprising:
a vineyard stake comprising a tubular member having first and second ends and a longitudinal axis;
an elongated training wire; and
first and second end posts for receiving first and second ends of the elongated training wire to maintain a tension in the elongated training wire;
wherein the tubular member includes an opening in a wall of the tubular member, the opening includes a central horizontal leg and first and second oppositely disposed vertical legs, and the horizontal and vertical legs form a protruding tab therebetween;
wherein the opening is configured to receive an intermediate portion of the elongated training wire therein and the protruding tab configured to retain the intermediate portion of the elongated training wire to fix the elongated training wire to the tubular member.

12. The vine training system of claim 11, wherein the tubular member includes a plurality of openings spaced along the longitudinal axis, and wherein the fires and second end posts each have a plurality of openings for positioning the elongated training wire a selected distance above a ground level.

13. The vine training system of claim 11, wherein the elongated training wire is selectively engageable with the vineyard stake without the use of a separate clip member.

14. The vine training system of claim 11, wherein the tubular member is a square tubular member, and wherein the opening spans an apex of the square tubular member.

15. The vine training system of claim 14, wherein the first and second vertical legs include ends that are angled toward the apex of the square tubular member.

16. The vine training system of claim 14, further comprising first and second horizontally oriented opening portions associated with ends of each of the first and second vertical legs, wherein the first and second horizontally oriented opening portions extend toward the apex of the square tubular member.

17. The vine training system of claim 16, wherein the first and second vertical legs comprise downwardly oriented vertical legs, the opening further comprising third and fourth vertical legs, wherein the third and fourth vertical legs are upwardly oriented.

18. The vine training system of claim 17, further comprising third and fourth horizontally oriented opening portions associated with ends of each of the third and fourth vertical legs, wherein the third and fourth horizontally oriented opening portions extend toward the apex of the square tubular member.

19. The vine training system of claim 11, wherein the tubular member has a zinc coating.

20. The vine training system of claim 11, wherein the first or second end includes at least one protrusion to facilitate penetration of soil when a force is applied to the other of the first or second end.

21. The vine training system of claim 11, wherein at least one of the first and second end posts includes a tensioning device operable to adjust a tension of the elongated training wire.

22. The vine training system of claim 21, wherein the tensioning device is a ratchet tensioner.

23. The vine training system of claim 21, wherein at least one of the first and second end posts includes an attachment element for receiving a first or second end of the elongated training wire
